(19) United States
(12) Patent Application Publication
(10) Pub. No.: US 2006/0230798 A1
(43) Pub. Date: Oct. 19, 2006

(54) Fertiliser

(75) Inventors: David McConchie, Goonellabah (AU); Malcolm William Clark, Lismore (AU); Fiona Gaye Davies-McConchie, Goonellabah (AU); Stephen Robert Walsh, Goonengarry (AU)

Correspondence Address: BUCHANAN, INGERSOLL & ROONEY LLP, P.O. BOX 1404, ALEXANDRIA, VA, 22313-1404, US

(73) Assignee: Mt. Aspring Geochemistry Consultants Pty, Ltd., East Lismore (AU)

(21) Appl. No.: 10/535,512

(22) PCT Filed: Nov. 18, 2003
(86) PCT No.: PCT/AU03/01546

§ 371 Date: Apr. 19, 2006

(30) Foreign Application Priority Data
Nov. 18, 2002 (AU) 2002952712

(51) Int. Cl. C05B 7/00

(52) U.S. Cl. 71/33

(57) ABSTRACT

The present invention relates to fertiliser composition comprising from 95% to 1% by weight, based on the total weight of the fertiliser composition, of a phosphate fertiliser and from 5% to 99% by weight, based on the total weight of the fertiliser composition, of a phosphate binding substance selected from the group consisting of red mud that has been at least partially reacted with a material comprising at least one of calcium ions and magnesium ions, red mud that has been at least partially neutralised by addition of acid, red mud that has been at least partially neutralised by treatment with carbon dioxide, and red mud that has been at least partially neutralised by addition of at least one mineral containing at least one of calcium ions and magnesium ions, the phosphate binding substance having a reaction pH, when mixed with 5 times its weight of water, of less than 10.5. There are further provided methods for preparing the fertiliser and methods for fertilising soils.

### TECHNICAL FIELD

The present invention relates to fertiliser compositions and to methods for fertilising soil.

### BACKGROUND OF THE INVENTION

Phosphorus is an essential trace element for all flora and fauna and because the export of produce from farms can remove phosphorus from the farm soil faster than natural weathering and related processes can replace it, the application of artificial phosphate fertilisers is commonly required to maintain agricultural productivity. The most commonly applied phosphate fertiliser in broadacre agriculture is superphosphate. However, there are several problems associated with the application of phosphate fertilisers to pastures and the most serious involves loss of the slightly soluble phosphate fertiliser from the farms to adjacent waterways. For many farming areas, it has been shown that between 40% and 60% of the phosphorus applied to pasture as superphosphate can be lost to nearby waterways during rainfall events; the exact loss rates depend on the soil type, slope of the land, soil organic matter status, soil mineralogy, etc. The dispersal of phosphorus from agricultural land via drainage networks to nearby waterways makes broadacre agriculture one of the greatest non-point sources of phosphorus contamination in creeks and rivers. This loss represents a major economic cost to farmers and causes an adverse environmental impact that can lead to excessive growth of aquatic flora and ultimately to eutrophication of the waterways. In practise, if 50% of the phosphorus applied to farms during top dressing is lost to nearby waterways, the farmers are effectively paying twice as much for the fertiliser required to meet their cropping needs as they would be if there was no phosphorus loss.

Consequently, there is a clear need to develop compositions and application strategies that will minimise phosphate loss from broadacre agricultural lands while maintaining the plant availability of the applied phosphate. Such compositions and application strategies will substantially improve both farm economics and the quality of water in waterways draining farmland.

The present inventors have surprisingly discovered that the loss of water soluble phosphate from soil treated with phosphate fertilisers can be substantially reduced, without loss of fertilising benefit of the applied phosphate, if bauxite refinery residue, known as red mud, that has been at least partially reacted so as to have a reaction pH of less than 10.5 is applied to the soil as well as the phosphate fertiliser.

### SUMMARY OF THE INVENTION

According to a first embodiment, the present invention provides a fertiliser composition comprising from 95% to 1% by weight, based on the total weight of the fertiliser composition, of a phosphate fertiliser and from 5% to 99% by weight, based on the total weight of the fertiliser composition, of a phosphate binding substance selected from bauxite refinery residue, known as red mud, that has been at least partially reacted with calcium and/or magnesium ions; red mud that has been at least partially neutralised by addition of acid; red mud that has been at least partially neutralised by treatment with carbon dioxide; and red mud that has been at least partially neutralised by addition of one or more minerals containing calcium and/or magnesium, the phosphate binding substance having a reaction pH, when mixed with 5 times its weight of water, of less than 10.5

One of the one or more minerals containing calcium and/or magnesium may be for example gypsum.

According to a second embodiment, the present invention provides a process for preparing a fertiliser composition, said process comprising homogeneously mixing a phosphate fertiliser and a phosphate binding substance, wherein the phosphate binding substance is selected from the group consisting of red mud that has been at least partially reacted with a material comprising at least one of calcium ions and magnesium ions, red mud that has been at least partially neutralised by addition of acid, red mud that has been at least partially neutralised by treatment with carbon dioxide, and red mud that has been at least partially neutralised by addition of at least one mineral containing at least one of calcium ions and magnesium ions, the phosphate binding substance having a reaction pH, when mixed with 5 times its weight of water, of less than 10.5.

According to a third embodiment, the present invention provides a method of fertilising soil comprising applying to the soil a fertilising amount of phosphate fertiliser and an amount of a phosphate binding substance wherein the amount of the phosphate fertiliser is from 95% to 1% by weight, based on the total weight of the phosphate fertiliser and the phosphate binding substance and the amount of the phosphate binding substance is from 5% to 99% by weight, based on the total weight of the phosphate fertiliser and the phosphate binding substance and wherein the phosphate binding substance is selected from bauxite refinery residue, known as red mud, that has been at least partially reacted with calcium and/or magnesium ions; red mud that has been at least partially neutralised by addition of acid; red mud that has been at least partially neutralised by treatment with carbon dioxide; and red mud that has been at least partially neutralised by addition of one or more minerals containing calcium and/or magnesium (such as gypsum), the phosphate binding substance having a reaction pH, when mixed with 5 times its weight of water, of less than 10.5.

Surprisingly, the present inventors have found that although the methods and compositions of the invention involve the use of a phosphate fertiliser with a phosphate binding substance, nevertheless in the methods of the invention such as when the compositions of the invention are applied to soils, the phosphate remains sufficiently available to plants for the phosphate fertiliser to retain its fertilising capability even though the phosphate is sufficiently bound that it is substantially prevented from being leached from the soil by rainfall, or at least its ability to be leached from the soil is appreciably decreased.

### BRIEF DESCRIPTION OF THE DRAWINGS

In the accompanying drawings, FIG. 1 is a graph showing the changes over 65 days in the concentration of phosphorus in aqueous solutions that are in contact with pellets containing various compositions in accordance with the invention, compared to pellets of superphosphate alone.

FIG. 2 is a graph showing the cumulative loss of phosphorus from pellets containing various compositions in accordance with the invention, compared to superphosphate alone, when subjected to a succession of simulated rainfall events.

### DETAILED DESCRIPTION OF THE INVENTION

In the fertiliser compositions and methods of the invention the phosphate fertiliser is any phosphate-containing substance known to the art for use for fertilising soils. Examples of such phosphate fertilisers include normal superphosphate, double superphosphate, triple superphosphate, monoammonium phosphate, diammonium phosphate, ammonium polyphosphate, nitric phosphate, struvite and phosphate rock. Usually the phosphate fertiliser is normal superphosphate or triple superphosphate or diammonium phosphate.

Preferably, the phosphate binding substance is red mud from bauxite refinery operations that has been at least partially reacted with calcium and/or magnesium ions so as to have a reaction pH, when mixed with 5 times its weight of water, of less than 10.5. More preferably the reaction pH, when mixed with 5 times its weight of water, is less than a value selected from the group consisting of about 10, about 9.5, about 9, about 8.5 and about 8. This material will be referred to herein as “treated red mud”. The reaction pH of treated red mud, when mixed with 5 times its weight of water, may be about 8-10.5, alternatively about 8.5-10, alternatively about 8.5-9.5, alternatively about 9-10, alternatively about 9.5-10, alternatively about 9-9.5, and may be about 10.5, 10, 9.5, 9, 8.5 or 8.

One method by which treated red mud, as defined herein, may be prepared is by reacting red mud with calcium and/or magnesium ions as described in International Patent Application No. PCT/AU03/00865 and International Patent Application No. PCT/AU01/01383, the contents of which are incorporated herein in their entirety. Another way in which treated red mud may be prepared is by reaction of red mud with sufficient quantity of seawater to decrease the reaction pH of the red mud to less than 10.5. For example, it has been found that if an untreated red mud has a pH of about 13.5 and an alkalinity of about 20,000 mg/L, the addition of about 5 volumes of world average seawater will reduce the pH to between 9.0 and 9.5 and the alkalinity to about 300 mg/L.

As taught in International Patent Application No. PCT/AU03/00865 and International Patent Application No. PCT/AU01/01383, a process for reacting red mud with calcium and/or magnesium ions may comprise mixing red mud with an aqueous treating solution containing a base amount and a treating amount of calcium ions and a base amount and a treating amount of magnesium ions, for a time sufficient to bring the reaction pH of the red mud, when one part by weight is mixed with 5 parts by weight of distilled or deionised water, to less than 10.5. The base amounts of calcium and magnesium ions are 8 millimoles and 12 millimoles, respectively, per litre of the total volume of the treating solution and the red mud; the treating amount of calcium ions is at least 25 millimoles per mole of total alkalinity of the red mud expressed as calcium carbonate equivalent alkalinity and the treating amount of magnesium ions is at least 400 millimoles per mole of total alkalinity of the red mud expressed as calcium carbonate equivalent alkalinity. Suitable sources of calcium or magnesium ions include any soluble or partially soluble salts of calcium or magnesium, such as the chlorides, sulfates or nitrates of calcium and magnesium. As taught in International Patent Application No. PCT/AU03/00865 and International Patent Application No. PCT/AU01/01383, examples of sources of calcium and magnesium include hard groundwater brines, natural saline brines (e.g. evaporatively concentrated seawater, bittern brines from salt mines or salt lake brines), saline wastewaters (e.g. from desalination plants), and solutions made by dissolving calcium chloride and magnesium chloride. However, sources of calcium and/or magnesium ions are not limited to these examples.

A further method by which treated red mud may be prepared comprises the steps of:

(a) contacting the red mud with a water soluble salt of an alkaline earth metal, typically calcium or magnesium or a mixture of the two, so as to reduce at least one of the pH and alkalinity of the red mud; and

(b) contacting the red mud with an acid so as to reduce the pH of the red mud to less than 10.5.

Optionally, this process may further include the step of separating liquid phase from the red mud after step (a) and before step (b).

In step (a) of this process, the pH of the red mud is usually reduced to about 8.5-10, alternatively to about 8.5-9.5, alternatively to about 9-10, alternatively to about 9.5-10, preferably from about 9-9.5, and may be reduced to a value selected from the group consisting of about 10.5, about 10, about 9.5, about 9, about 8.5 and about 8.

In step (a) of this process, the total alkalinity, expressed as calcium carbonate alkalinity, of the red mud may be reduced to about 200 mg/L-1000 mg/L, alternatively to about 200 mg/L-900 mg/L, alternatively to about 200 mg/L-800 mg/L, alternatively to about 200 mg/L-700 mg/L, alternatively to about 200 mg/L-600 mg/L, alternatively to about 200 mg/L-500 mg/L, alternatively to about 200 mg/L-400 mg/L, alternatively to about 200 mg/L-300 mg/L, alternatively to about 300 mg/L-1000 mg/L, alternatively to about 400 mg/L-1000 mg/L, alternatively to about 500 mg/L-1000 mg/L, alternatively to about 600 mg/L-1000 mg/L, alternatively to about 700 mg/L-1000 mg/L, alternatively to about 800 mg/L-1000 mg/L, alternatively to about 900 mg/L-1000 mg/L, preferably less than 300 mg/L, and may be reduced to less than a value selected from the group consisting of about 1000 mg/L, about 900 mg/L about 800 mg/L about 700 mg/L about 600 mg/L, about 500 mg/L, about 400 mg/L, about 300 mg/L and about 200 mg/L or may be reduced to a value selected from the group consisting of about 1000, about 950, about 900, about 850, about 800, about 750, about 700, about 650, about 600, about 550, about 500, about 450, about 400, about 350, about 300, about 250 and about 200 mg/L.

In step (b) of this process, the pH is typically reduced to less than about 9.5, preferably to less than about 9.0, and may be reduced to a value selected from the group consisting of about 9.5, about 9.25, about 9.0, about 8.75, about 8.5, about 8.25 and about 8 and the total alkalinity, expressed as calcium carbonate equivalent alkalinity, is preferably reduced to less than a value selected from the group consisting of about 200 mg/L, about 150 mg/L and about 100 mg/L, and may be reduced to a value selected from the group consisting of about 200, about 175, about 150, about 125, about 100, about 75 and about 50 mg/L.

As described in International Patent Application No. PCT/AU03/00865 and International Patent Application No. PCT/AU01/01383, treated red mud, as defined herein, is a dry red solid that consists of a complex mixture of minerals that usually includes: abundant hematite, boehmite, gibbsite, sodalite, quartz and cancrinite, minor aragonite, brucite, calcite, diaspore, ferrihydrite, gypsum, hydrocalumite, hydrotalcite, p-aluminohydrocalcite and portlandite, and a few low solubility trace minerals. It has a high acid neutralising capacity (2.5-7.5 moles of acid per kg of treated red mud) and a very high trace metal trapping capacity (greater than 1,000 milliequivalents of metal per kg of treated red mud); it also has a high capacity to trap and bind phosphate and some other chemical species. Treated red mud can be produced in various forms to suit individual applications (e.g. slurries, powders, pellets, etc.) but all have a near-neutral soil reaction pH (less than 10.5 and more typically between 8.2 and 8.6) despite their high acid neutralising capacity. The soil reaction pH of treated red mud is sufficiently close to neutral and its TCLP (Toxicity Characteristic Leaching Procedure) values are sufficiently low that it can be transported and used without the need to obtain special permits.

A preferred phosphate binding substance is the treated red mud that is available from Virotec International Pty Ltd of Sanctuary Cove, Queensland, Australia, under the trademark Bauxsol.

It will be appreciated form the foregoing, however, that the phosphate binding substance for use in the fertiliser compositions and methods of the present invention is not limited to treated red mud, as herein defined, and may also be red mud that has been at least partially neutralised by treatment with acid; red mud that has been at least partially neutralised by treatment with carbon dioxide; or red mud that has been at least partially neutralised by addition of one or more minerals containing calcium and/or magnesium (such as gypsum). Red mud may conveniently be at least partially neutralised by treatment with carbon dioxide, by bubbling carbon dioxide into an aqueous suspension of red mud, or by injecting carbon dioxide into such a suspension under pressure, until the reaction pH of the red mud is decreased to less than a value selected from the group consisting of about 10.5, about 10.0, about 9.5 and about 9.0 or until the reaction pH of the red mud has a value selected from the group consisting of about 10.5, about 10.0, about 9.5, about 9.0 and about 8.5.

A particular benefit of using treated red mud in the compositions and methods of the invention is that the trace metal binding capacity of the treated red mud will reduce trace metal uptake by plants. This effect can be particularly important where metal contaminated phosphate fertilisers may be used. Many phosphate fertilisers contain very large amounts of potentially hazardous trace elements such as cadmium and uranium and prolonged use of these fertilisers on farms has led to the contamination of crops, leaving them unfit for human consumption. In the worst cases, it has been necessary to prohibit the production of crops for human consumption on farms that have used metal-rich phosphate fertilisers for prolonged periods. The addition of treated red mud to such farms will substantially reduce trace metal uptake by plants and at appropriate application rates can allow the production of crops for human consumption to resume.

In the compositions of the invention the relative amounts of phosphate fertiliser and the phosphate binding substance can be varied to suit the needs of particular applications. The composition includes from 5% to 99% by weight of the phosphate binding substance and from 95% to 1% by weight of phosphate fertiliser. However, preferred compositions include from 20% to 85% by weight of the phosphate binding substance and from 80% to 15% by weight of phosphate fertiliser, and more preferred compositions include from 50% to 75% by weight of the phosphate binding substance and from 50% to 25% by weight of phosphate fertiliser. The composition may include about 5, 10, 15, 20, 25, 30, 35, 40, 45, 50, 55, 60, 65, 70, 75, 80, 85, 90, 95, 96, 97, 98 or 99% by weight of the phosphate binding substance and about 95, 90, 85, 80, 75, 70, 65, 60, 55, 50, 45, 40, 35, 30, 25, 20, 15, 10, 5, 4, 3, 2 or 1% by weight of phosphate fertiliser. All weight percentages are expressed as percentages of the total weight of the composition.

Other components such as nitrogen or potassium containing substances (for example ammonium nitrate or potassium nitrate) can be added to the composition as required to achieve the desired nutrient balance for a particular soil. Similarly, trace metals such as copper, zinc, molybdenum, etc. can be added to the compositions as required to ensure the appropriate nutrient and micro-nutrient availability for the soil to be fertilised with the composition. Although the inclusion of treated red mud in the compositions of the invention inhibits the uptake of trace metals by plants, it does not completely stop this uptake, and consequently, it is possible to adjust trace metal availability to plants by inclusion of appropriate amounts of trace metals in the compositions of the invention. Similarly, trace elements and other fertiliser components may be applied to the soil in a method of the second embodiment of the invention, in addition to the phosphate fertiliser and the phosphate binding substance.

The amount of the phosphate binding substance in the compositions of the invention will typically be greater than about 50% by weight, and may be greater than about 55, 60, 65, 70 or 75%, and will usually be greater than about 80%, where the soil to which the composition is to be applied is already contaminated with potentially hazardous trace metals such as cadmium or uranium or where the phosphate fertiliser being used has a sufficiently high content of these metals that it could lead to contamination of the soil.

The amount of the phosphate binding substance in the compositions of the invention will also typically be greater than about 50% by weight, and may be greater than about 55, 60, 65, 70 or 75%, and will usually be greater than 80%, where the soil reaction pH is undesirably low; such as less than 5.5.

The compositions of the invention may be provided in the form of a blend or they may be formulated as mixtures of powders, granules, pellets or tablets of the separate components, or as powders, granules, pellets or tablets composed of the mixed components. Preferably, the compositions of the invention are provided in the form of pellets made from an intimate mixture of the components of the composition. Similarly, in the methods of the third embodiment, the phosphate fertiliser and the phosphate binding substance may be applied separately, as powders, granules, pellets of each component, or the like, or they may be applied together in the form of a composition of the first embodiment. If the phosphate fertiliser and the phosphate binding substance are applied separately, they may be applied in any order. That is, the phosphate fertiliser may be applied before or after the phosphate binding substance. If the two are applied separately, the time between the applications may be short, of the order of minutes, or longer, such as an hour, several hours, a day, several days, a week or several weeks. Preferably, the phosphate fertiliser and the phosphate binding substance are applied together, or separately but within a relatively short time, such as within a day, of each other.

The amount of phosphate fertiliser applied will be readily determined by persons skilled in the art, based on known application rates of phosphate fertilisers, after taking account of the fact that in the methods of the present invention substantially all the phosphate applied is available as fertiliser and substantially none will be lost to waterways, especially if an approximately equal weight of the phosphate binding substance is also applied. Application rates of the phosphate fertiliser may commonly be between about 50 and 90% of the application rate needed in the absence of the phosphate binding substance, and may be between about 50 and 80% or between about 50 and 70% or between about 50 and 60% of the application rate needed in the absence of the phosphate binding substance, and will thus typically be about 90%, more typically about 80%, still more typically about 70%, even more typically about 60% and most typically about half the application rate needed in the absence of the phosphate binding substance.

A composition of the present invention is typically prepared by blending the phosphate fertiliser with the phosphate binding substance and any other constituents that may be desired, as exemplified above, and thoroughly mixing them to ensure that the mixture is homogeneous. Any coarse particles are preferably crushed or ground. After said crushing or grinding, the particle diameter may be less than about 0.5 mm, or less than about 0.4, 0.3, 0.2 or 0.1 mm, and may be about 0.5, 0.4, 0.3, 0.2, 0.1, 0.07, or 0.05 mm, and may commonly be less than 0.1 mm particle diameter.

The resulting homogeneous mixture can be used in the powdered form, but more commonly it will be desirable to pelletise the material. Pelletisation can be readily achieved by pressing the homogeneous mixture into pellets by using a hydraulic press, or compression rollers, or a prilling machine, or any other similar means determined to be convenient or efficient. Pressed pellets that are strong and stable enough to survive transport and moderately rough handling can be readily formed using an applied compression of about 50 MPa or more. However, an applied compression of greater than about 150 MPa is preferred and an applied compression of greater than about 250 MPa is still more preferred. Applied compression of about 50, 100, 150, 200, 250, 300, 350 or 400 MPa, or between about 50 and 500 MPa, or between about 100 and 450 MPa, or between about 150 and 400 MPa or between about 200 and 350 MPa may be used. Strong and stable pellets may also be produced from a damp slurry that has been prepared by adding water to the homogeneous mixture. At a suitable moisture content pellets can be prepared by rolling the mixture with little or no compression; commercially available pellet binders (used in the chemical, pharmaceutical, or similar industries; for example methylcellulose or other cellulose derivatives) can be added to the mixture to provide additional physical strength if desired.

The methods of the present invention will have the following benefits compared to prior art fertilisation methods.

1. Where fertiliser compositions of the present invention are applied to soils, only a very small proportion (typically less than 1%) of the applied phosphorus will be capable of being leached from the soil by rainfall, compared to about 50% of ordinary superphosphate that is commonly removed by leaching under prior art practices.

2. Fertiliser compositions and methods of the present invention can help reduce the uptake of potentially hazardous trace metals by plants grown on treated soils.

3. Fertiliser compositions and methods of the present invention will help reduce acidity in soils with a low soil reaction pH. Treatment with the fertiliser compositions of the present invention will also encourage the release of soil-bound phosphorus that is not available to plants at pH conditions below about 5.0.

4. The methods of the present invention will ensure that users of the fertiliser compositions obtain close to the full benefit from the phosphate fertiliser that they apply as compared to losses of around 50% when conventional phosphate fertilisers are used. Greater than 95% of the applied phosphate will remain readily available to the user's crops.

5. The use of the fertiliser compositions of the present invention will ensure that the loss of phosphorus to nearby waterways is reduced to very low levels and that the risk of eutrophication in the waterways is thereby minimised.

### EXAMPLES

### Example 1

### Leaching of Phosphate from Pellets of Bauxsol and Superphosphate

Pressed pellets with a range of Bauxsol™ to superphosphate fertiliser ratios were prepared as described herein using a hydraulic press with a 294 MPa applied compression. The resulting pellets were about 1 cm in diameter, and about 3 mm in thickness with an average weight of 1 g. Several pellets were accurately weighed into flasks and 100 mL of Milli-Q water was added. The pellets and the water were allowed to come to equilibrium over several days and the water was periodically sub-sampled and analysed for phosphate as P. The weight of pellets was selected to ensure that an excess of solid was present, to ensure that equilibrium could be reached. After each sample of water was removed, the quantity of removed water was replaced with fresh Milli-Q water and the mixture was allowed to stand for several more days before the next sub-sample was withdrawn. The trial was run for 65 days to establish the partitioning of phosphorus between the solid and liquid phases.

FIG. 1 shows the changes over 65 days in the concentrations of phosphorus in the aqueous solutions in contact with the pellets of superphosphate and Bauxsol™. The data show that incorporation of Bauxsol™ into the pellets substantially decreases the equilibrium proportion of phosphorus in solution compared to the amount of solid superphosphate added from close to 1,000 mg/L, to less than 2 mg/L P. These data indicate that the amount of soluble phosphate released by the Bauxsol™ treated pellets is about 500 times less than the amount released by the untreated superphosphate. However, despite this very large reduction in the phosphorus leaching potential, more than 95% of the phosphorus in the Bauxsol™ treated pellets remains plant available (as measured by standard plant available phosphorus tests used in agronomy).

### Example 2

### Leaching of Phosphorus from Compositions of the Invention by Simulated Rainfall Events

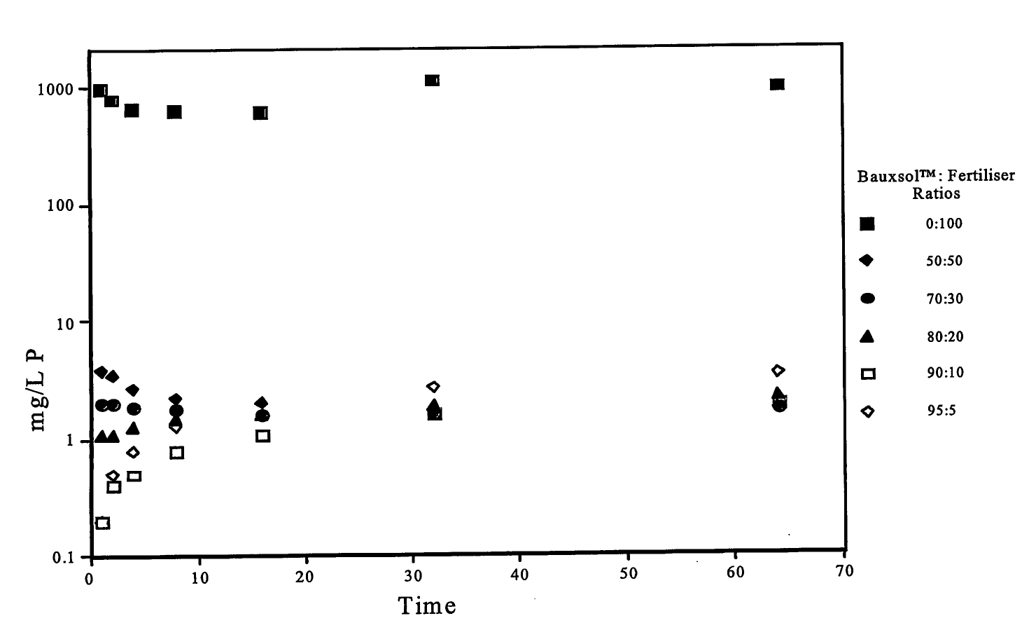

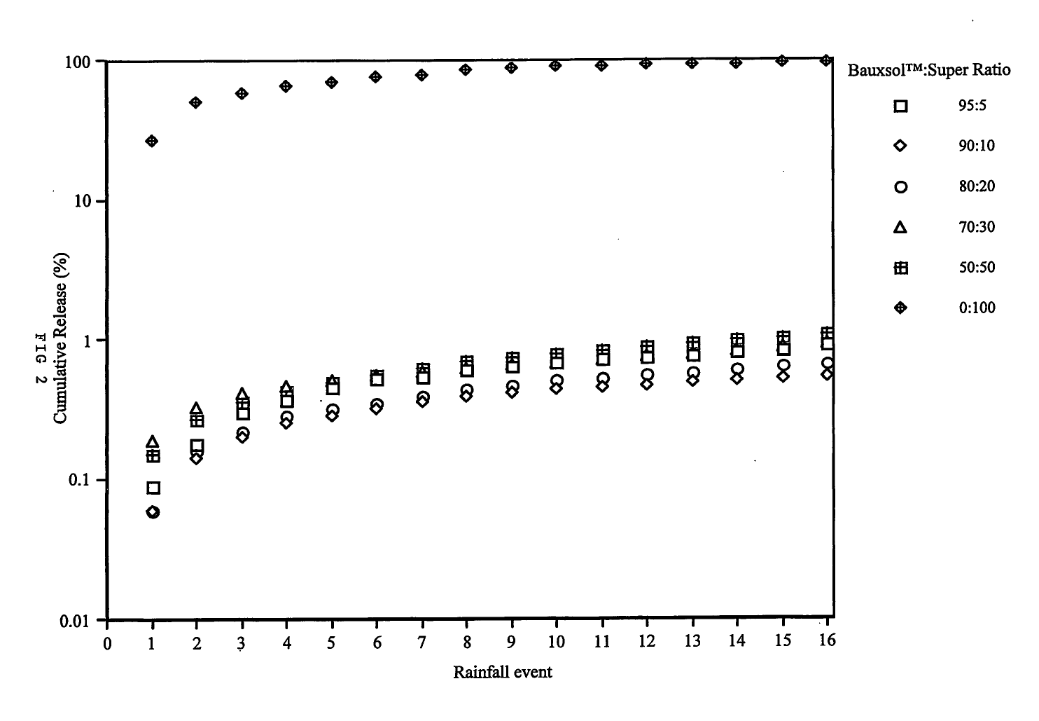

This trial simulates the effect of repeated rainfall events on the pellets prepared using different proportions of superphosphate and Bauxsol™. Several pellets, weighing in total 1 g, were placed in a beaker, and 100 mL of Milli-Q water of added. The pellets were agitated for 5 minutes and allowed to stand for 1 hour. The water was then removed for analysis and replaced with fresh Milli-Q water and the process was repeated. Given the surface area of the beaker, the volume of water added and the mass of phosphate present, each rinse was roughly equivalent to 30 mm of rainfall over an hour falling on well drained soil fertilised at typical superphosphate application rates. The liquid decanted with each rinse was analysed for P and the cumulative phosphorus loss was recorded as a proportion of total P available. FIG. 2 shows the cumulative loss of phosphorus from the pellets as a proportion of the total phosphorus available within each blend. In FIG. 2 the scale on the phosphorus loss axis is logarithmic. The total number of rainfall events simulated is equivalent to 1080 mm of rainfall, which for many parts of the world represents substantially less than a year's rainfall. These data show that where superphosphate is blended with Bauxsol™ the leachable P is reduced from nearly 100% of available P to <1% of the available P.

1. A fertiliser composition comprising from 95% to 1% by weight, based on the total weight of the fertiliser composition, of a phosphate fertiliser and from 5% to 99% by weight, based on the total weight of the fertiliser composition, of a phosphate binding substance selected from the group consisting of red mud that has been at least partially reacted with a material comprising at least one of calcium ions and magnesium ions, red mud that has been at least partially neutralised by addition of acid, red mud that has been at least partially neutralised by treatment with carbon dioxide, and red mud that has been at least partially neutralised by addition of at least one mineral containing at least one of calcium ions and magnesium ions, the phosphate binding substance having a reaction pH, when mixed with 5 times its weight of water, of less than 10.5.

2. A fertiliser composition according to claim 1 comprising from 50% to 25% by weight, based on the total weight of the fertiliser composition, of the phosphate fertiliser and from 50% to 75% by weight, based on the total weight of the fertiliser composition, of the phosphate binding substance.

3. A fertiliser composition according to claim 1 wherein the phosphate binding substance is a red mud that has been at least partially neutralised by treatment with carbon dioxide.

4. A fertiliser composition according to claim 1 additionally comprising one or more components selected from the group consisting of nitrogen containing compounds, potassium containing compounds and trace metals.

5. A fertiliser composition according to claim 1 in a form selected from the group consisting of powder, granules, pellets and tablets.

6. A fertiliser composition according to claim 1 wherein one of at least one mineral containing at least one of calcium ions and magnesium ions is gypsum.

7. A treated red mud when used in a fertiliser composition according to claim 1.

8. A process for preparing a fertiliser composition, said process comprising homogeneously mixing a phosphate fertiliser and a phosphate binding substance, wherein the phosphate binding substance is selected from the group consisting of red mud that has been at least partially reacted with a material comprising at least one of calcium ions and magnesium ions, red mud that has been at least partially neutralised by addition of acid, red mud that has been at least partially neutralised by treatment with carbon dioxide, and red mud that has been at least partially neutralised by addition of at least one mineral containing at least one of calcium ions and magnesium ions, the phosphate binding substance having a reaction pH, when mixed with 5 times its weight of water, of less than 10.5.

9. A process according to claim 8 wherein the amount of phosphate fertiliser is from 95% to 1% by weight based on the total weight of the phosphate fertiliser and the amount of phosphate binding substance is from 5% to 99% by weight based on the total weight of the phosphate fertiliser.

10. A process according to claim 8 wherein the amount of phosphate fertiliser is from 50% to 25% by weight based on the total weight of the phosphate fertiliser and the amount of phosphate binding substance is from 50% to 75% by weight based on the total weight of the phosphate fertiliser.

11. A process according to claim 8 wherein the phosphate binding substance is a red mud that has been at least partially neutralised by treatment with carbon dioxide.

12. A process according to claim 8 additionally comprising the step of adding one or more components selected from the group consisting of nitrogen containing compounds, potassium containing compounds and trace metals.

13. A process according to claim 8 additionally comprising the step of crushing or grinding coarse particles to a particle size of less than 0.1 mm particle diameter.

14. A process according to claim 8 additionally comprising the step of pelletising the mixture.

15. A process according to claim 14 using an applied compression of at least about 50 Mpa.

16. A fertiliser composition when made by the process of claim 8.

17. A method of fertilising soil comprising applying to the soil a fertilising amount of phosphate fertiliser and an amount of a phosphate binding substance wherein the amount of the phosphate fertiliser is from 95% to 1% by weight, based on the total weight of the phosphate fertiliser and the phosphate binding substance, and the amount of the phosphate binding substance is from 5% to 99% by weight, based on the total weight of the phosphate fertiliser and the phosphate binding substance, and wherein the phosphate binding substance is selected from the group consisting of red mud, that has been at least partially reacted with a material comprising at least one of calcium ions and magnesium ions, red mud that has been at least partially neutralised by addition of acid, red mud that has been at least partially neutralised by treatment with carbon dioxide, and red mud that has been at least partially neutralised by addition of at least one mineral containing at least one of calcium ions and magnesium ions, the phosphate binding substance having a reaction pH, when mixed with 5 times its weight of water, of less than 10.5.

18. A method according to claim 17 wherein the amount of phosphate fertiliser is from 50% to 25% by weight based on the total weight of the phosphate fertiliser and the amount of phosphate binding substance is from 50% to 75% by weight based on the total weight of the phosphate fertiliser.

19. A method according to claim 17 wherein the phosphate binding substance is a red mud that has been at least partially neutralised by treatment with carbon dioxide.

20. A method of fertilising soil comprising applying to the soil a fertilising amount of a fertilising composition according to claim 1.

21. A fertiliser composition according to claim 1 when used for fertilising soil.
